(19) United States
(12) Patent Application Publication
(10) Pub. No.: US 2026/0300351 A1
(43) Pub. Date: Oct. 1, 2026

(54) USING LEARNING OBJECTIVES TO IMPROVE SEARCH RESULTS

(71) Applicant: Meta Platforms Technologies, LLC, Menlo Park, CA (US)

(72) Inventors: Vyzantinos Repantis, Seattle, WA (US); Patrick Graves, Pleasant Hill, CA (US); Michael W. Thot, Seattle, WA (US); Ethan Welborn, Liberty Hill, TX (US); Vaidyanathan PK, Menlo Park, CA (US); Harshvardhan Singh, Menlo Park, CA (US)

(21) Appl. No.: 19/091,502

(22) Filed: Mar. 26, 2025

(51) Int. Cl. G06F 16/334; G06F 16/901

(52) U.S. Cl. CPC G06F 16/3347; G06F 16/9024

(57) ABSTRACT

A method of the subject technology includes receiving, by a search frontend or API, a query from a knowledge consumer, and processing the query via a processor. The processing includes generating embedding for the query, retrieving a plurality of learning objectives (LOs) relevant to the query based on the generated embeddings, and retrieving content relevant to the plurality of LOs. providing the content relevant to the plurality of LOs for display to the knowledge consumer. The knowledge consumer can be human user, a computer program or a machine.

### TECHNICAL FIELD

The present disclosure generally relates to search, and more particularly, to a search solution using learning objectives to improve search results.

### BACKGROUND

The current state of technology in document indexing and retrieval predominantly utilizes approximate nearest neighbor (ANN) search techniques. These methods have been effective in identifying and retrieving documents based on similarity measures, allowing users to find relevant information within large datasets. However, a significant limitation of existing ANN search methods is their inability to effectively index and retrieve chunked documents that are directly relevant to specific user queries at a knowledge level, relating to the author's intent versus word or token similarity. This shortcoming arises because ANN search techniques are generally designed to handle entire documents or large sections, rather than smaller, contextually relevant chunks. As a result, users often face challenges in locating the most pertinent information within a document, leading to inefficiencies and less accurate search outcomes.

An advanced search solution that can address this limitation by enabling the indexing of chunked documents in a manner that is directly relevant to user queries at a cognitive level is of interest. Some definitions follow: A “Knowledge consumer” (typically, a learner) refers to any entity—whether human, a digital program, or a machine—that engages with content to acquire knowledge or skills. This term encompasses a wide range of consumers and audiences, including individual humans, digital services, or machine learning models during their training processes. A learning objective (LO) is a statement that defines what the content or learning material (such as a paragraph, diagram, video segment, or code snippet) aims to achieve for its audience. It highlights the author's intent and specifies what knowledge consumers will remember, understand, apply, and so on, after consuming that content. Example: After studying this content, a learner should be able to: Describe the use of the world locking feature in the mixed reality utility kit (MRUK). An LO is not a summary of the content. It is a statement (typically one sentence) that defines what knowledge consumers are expected to achieve or demonstrate after engaging with the content, therefore, LOs define the content author's intent.

In computer science and math, a graph is a data structure made up of nodes and edges. Nodes represent entities, and edges connect node pairs. Graphs model relationships and structures, like networks. Nodes are the basic units of a graph, representing entities or points. In a knowledge dependency graph, each node can represent a distinct piece of knowledge, a fact, a concept, or a process. Edges connect nodes in a graph. They can be directed or undirected, showing if the relationship between nodes has a direction. In a knowledge dependency graph, an edge may represent a prerequisite relationship, indicating how one piece of knowledge is foundational to another. Weights are numerical values assigned to edges in a weighted graph. They represent the cost, distance, or capacity of connections between nodes. In a transportation network, weights indicate the distance or travel time between locations. In knowledge dependency graphs, a weight defines the strength of the relationship between two distinct pieces of knowledge. Semantic search is a search technique that aims to improve search accuracy by focusing on the semantic similarity and contextual meaning of search queries, rather than matching keywords.

### SUMMARY

Some aspects of the subject disclosure are directed to a method including generating, by a system, a representation for a data point. This representation involves mapping each data point to content pieces as internal metadata. The process includes defining a unique identifier for each data point, associating a learning objective (LO) statement in natural language, and linking to various content sources such as text, video, or code. The metadata structure facilitates the connection of data point descriptions to multimodal content, enabling efficient information retrieval.

Some aspects of the subject disclosure are directed to a method including receiving, by a search frontend or otherwise, a query from a knowledge consumer (e.g., a human user, a program, or a machine), and processing the query via a processor. The processing includes generating embedding for the query, retrieving a plurality of learning objectives (LOs) relevant to the query based on the generated embeddings, retrieving content relevant to the plurality of LOs, and providing the content relevant to the plurality of LOs for display to the user.

Other aspects of the subject disclosure are directed to a system including a processor and memory coupled to the processor, the memory storing instructions that, when executed by the processor, cause the processor to perform a method. The method includes receiving a query from a knowledge consumer (e.g., a human user, a program, or a machine) and processing the query. The processing includes generating embedding for the query, retrieving a plurality of LOs relevant to the query based on the generated embeddings, retrieving content relevant to the plurality of LOs, and providing the content relevant to the plurality of LOs for display to the user.

Yet other aspects of the subject disclosure are directed to a method including receiving, by a search frontend, a search query or a question asked in a natural language from a knowledge consumer (e.g., a human user, a program, or a machine) and processing the query via a processor. The processing includes retrieving a plurality of LOs relevant to the query based on an embedding generated for the query, retrieving content relevant to the plurality of LOs from an LO-to-content inverted index database, and providing the content relevant to the plurality of LOs for display to the knowledge consumer (e.g., a human user, a program, or a machine).

### BRIEF DESCRIPTION OF THE DRAWINGS

To easily identify the discussion of any particular element or act, the most significant digit or digits in a reference number refer to the figure number in which that element is first introduced.

FIG. 1A is a block diagram illustrating an example system architecture within which some aspects of the subject technology are implemented.

FIG. 1B is a high-level diagram illustrating an example mapping of a learning objective (LO) to a metadata, in accordance with some aspects of the subject technology.

FIG. 2 is a diagram illustrating an example of a protype of a user experience, in accordance with some aspects of the subject technology.

FIG. 3 is a block diagram illustrating an example system architecture of an LO-based sematic search, in accordance with some aspects of the subject technology.

FIG. 4 is a block diagram illustrating an example of a system for an LO-based sematic search for any knowledge consumer, in accordance with some aspects of the subject technology.

FIG. 5 is a block diagram illustrating an example of a sample search system capable of outputting LOs for any knowledge consumer, in accordance with some aspects of the subject technology.

FIG. 6 is a schematic diagram illustrating an example of an LO graph, in accordance with some aspects of the subject technology.

FIG. 7 is a schematic diagram illustrating an example of an LO graph and a prerequisite search, in accordance with some aspects of the subject technology.

FIG. 8 is a schematic diagram illustrating an example graph of an LO search and a what's next search, in accordance with some aspects of the subject technology.

FIG. 9 is a schematic diagram illustrating an example graph of an LO search and a prerequisite learning journey, in accordance with some aspects of the subject technology.

FIG. 10 is a schematic diagram illustrating an example graph of an LO search and a subsequent learning journey, in accordance with some aspects of the subject technology.

FIG. 11 is a schematic diagram illustrating an example of a system for an LO search and an objective journey, in accordance with some aspects of the subject technology.

FIG. 12 is a schematic diagram illustrating an example of graphs of personalized edge weights for individual knowledge consumers, in accordance with some aspects of the subject technology.

FIG. 13 is a schematic diagram illustrating an example of a system for an LO search and individualized prerequisites, in accordance with some aspects of the subject technology.

FIG. 14 is a schematic diagram illustrating an example graph of an algorithm for a personalized search, in accordance with some aspects of the subject technology.

FIG. 15 is a schematic diagram illustrating an example graph of an algorithm for objective determination of LOs to visit to reach a target LO, in accordance with some aspects of the subject technology.

FIG. 16 is a diagram illustrating an example of a computer system within which some aspects of the subject technology are implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

The subject disclosure is directed to a search solution using learning objectives to improve search results. The disclosed technique differentiates with indexing learning objectives connected to the documents of various formats, such as text, video segments, code snippets, and images, with a graph representing knowledge dependencies to offer a better search and learning experience to knowledge consumers dynamically, based on their needs.

Modern search solutions face several challenges including: 1) These search solutions depend on and reflect the quality of content. They are plain content-based search mechanisms and indexing relies on the content itself. 2) They provide all information indiscriminately, which requires users to sift through every piece of content. 3) They match the search space size with the content size; therefore, the larger the content space, the wider the search space. 4) They retrieve content in a single, specified format, usually plain text. Multimodal, media-agnostic context retrieval is impossible due to non-unified search space formats. For example, no unified search solution currently retrieves text from documentation, code snippets, and video segments as a result of a single query. 5) They reflect the actual content rather than the author's intent, and the content may be returned for a query even if another piece better reflects the author's intent. 6) They do not adapt to the user's expertise (reflected based on previous searches or previously consumed content), and they do not consider whether the prerequisite knowledge or the next logical piece of content to consume might be based on a unified learning journey.

In some aspects, the subject disclosure explicitly identifies and explicitly solves a technical problem associated with an efficient search mechanism based on learning objectives (LOs). Learning objectives are single sentences that represent the author's intent in relation to their actual content. Learning objectives can indicate what the audience may know or be able to do after engaging with the content. By mapping the learning objectives to the actual content using meta-tags, a compressed search space can be achieved. This allows for searching within a smaller corpus of these statements instead of the entire content. Using learning objectives also allows for mapping media-agnostic content to the author's actual intent. Therefore, a single query can return results in multiple medium formats. This can drive better search results, regardless of the content's quality per se. Such a search can always return the best possible content as intended by its authors.

The learning objectives may be essential for the disclosed solution, but they are not part of the main components of the subject disclosure. The main components can include building a graph of connected learning objectives and enabling multi-modal results; connecting learning objectives to anticipate next steps and/or prerequisite knowledge; and providing a mechanism to determine different learning paths based on user expertise or level of understanding, which guides individualized results. The disclosed solution has the potential to provide different learning paths based on the user's expertise or level of understanding, adapt its results, and match them with suitable content, even for the same query.

For example, consider a query about a software development kit (SDK) information such as “integrate spatial SDK” used by three different types of users or at a different point in their learning journey. A beginner user might explore basic concepts, a manager might decide on technology adoption, and a developer might seek detailed SDK information, but they may all input the same search query. The subject solution creates multiple learning paths based on learning objectives and can inform the results based on user needs. When a user shows interest in the spatial SDK, tailored content (e.g., based on prerequisite and subsequent learning objectives) is provided. Furthermore, given historical data on their search journey or the content they have previously consumed, beginner-level information can be offered, such as introductory video segments, even as portions of long video tutorials. For intermediate users, specific chunks of blog posts, code samples, and interactive exercises for deeper exploration are provided. For expert users, comprehensive documents and application-programing interfaces (APIs) related to the spatial SDK can be provided. This approach helps users find relevant documents based on their expertise level at a specific time.

Furthermore, typical indexing of new documents takes time, so it runs on a schedule, such as once a week. However, since LO indexing is faster and the search space is significantly smaller (e.g., more than 25 times smaller), it can occur soon after a new document or any content updates, providing knowledge consumers with fresh search information more quickly. Auditing content accuracy becomes easier too by dividing the test area into smaller sections. The search string points to LO, and the LO is linked to the correct documents or any form of content. Without this setup, auditing requires manually comparing the search string with the resulting documents one-by-one as a whole, which is tedious.

Finally, the disclosed approach is scalable, as it only requires a single learning objective to unify knowledge spaces A to B by interconnecting that particular learning objective as a common node between two subgraphs. For example, marketing material to developer material, or code snippets to design considerations about developing XR apps for collocated users in the same space can all tie together through the same learning objective such as “remember what a spatial anchor is.” Edges from that common learning objective may lead to any knowledge subdomain.

The importance of the disclosed solution arises from the following facts. Website results on a company developer site can often be inaccurate or non-existent. The disclosed method provides a way to unify media-agnostic, multimodal search results versus text-only and allows for individualized and adaptive user pathways based on learning pathways. The graph artifact representing knowledge dependencies forms the internal foundation for developing learning or educational curricula aimed at any knowledge consumer.

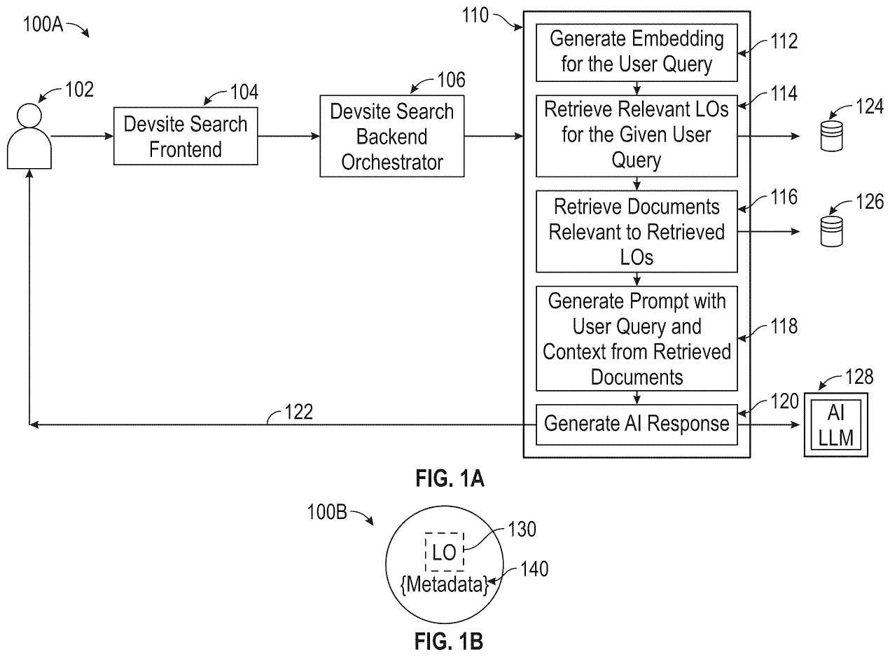

Turning now to the figures, FIG. 1A is a block diagram illustrating an example system architecture 100A within which some aspects of the subject technology are implemented. The system architecture 100A includes a device-site search frontend 104 (hereinafter, search frontend 104), a device-site search backend orchestrator 106 (hereinafter, search backend 106), an application programming interface (API) 110, an LOs vector database (DB) 124 (hereinafter, DB 124), an LO to documents inverted index DB 126 (hereinafter, DB 126) and an artificial intelligence (AI) large-language model (LLM) 128. A user 102 can enter a search query into a device (e.g., a computer such as a desktop or a laptop, a tablet, a mobile phone or any other device) through the search frontend 104. The search query is transferred to the API 110 via the search backend 106.

In some implementations, the API 110 executes several steps including steps 112, 114, 116, 118 and 120. In step 112, embedding for the user search query is generated. Generating embeddings typically involves transforming data into a numerical format that machine learning models can understand. Examples of embedding include word embedding, sentence embedding, image embedding, graph embedding and the like. In step 114, the generated embeddings are used to retrieve relevant LOs for the given user query from the LOs vector DB 124. In step 116, the documents relevant to the retrieved LOs are retrieved from DB 126. In step 118, a prompt is generated from the user query and context from the retrieved documents. Generating the prompt may involve creating a structured input that guides a model to produce the desired output. The prompt clearly states what a user wants to achieve or the question that needs to be answered. The prompt may also include any relevant background information or details that can help the model understand the query better. In step 120, using the AI LLM 128, an AI response 122 is generated for the user 102.

FIG. 1B is a high-level diagram 100B illustrating an example mapping of a learning objective (LO) 130 to metadata 140, in accordance with some aspects of the subject technology. The metadata 140 connects the LO 130 description to multimodal content. A general pattern of such metadata is shown in the following first example listing in plain JavaScript object natation (JSON) format.

| | |
|---|---|
| { | |
| “learning_objectives”: [ | |
| { | |
| “id”: “Unique id of LO”, | [1] |
| “LO_statement”: “LO statement in natural language”, | [2] |
| “content_source”: { | [3] |
| “markdown”: “a link to text content, if any”, | |
| “video”: “a link to video content, if any”, | |
| “code”: “a link to code snippet, if any”, | |
| ... | |
| }, | [4] |
| “section_mapping”: { | [5] |
| “markdown_header”: [“Section, “Subsection”, | |
| “Subsubsection”, ...], | |
| “video_segment”: { | |
| “start”: starting_point_in_sec, | [6] |
| “end”: ending_point_in_sec | |
| }, | |
| “code_lines”: { | |
| “start”: code_line_start, | |
| “end”: code_line_end | |
| }, | |
| ... | |
| }, | |
| }, | |
| ] ... | |
| } | |

In the first listing shown above, segments 1 through 6 are described in the following. [1] Defines a unique identifier; [2] Is the LO statement in plain text. This is the field against which the search will occur. [3] Links to the content source where this LO maps, such as markdown text, video links, or code links, where at least one link must exist. [4] Text sections (if in markdown format) defined by the header section. [5] Video segments (if in video format) defined by start and end points (in seconds). [6] Code lines (if a code snippet) defined by start and end code lines.

Another sample in a second listing shown and described below provides an example of how an LO contains metadata that defines text content.

| | |
|---|---|
| { | |
| “learning_objectives”: [ | |
| { | |
| “id”: “LO27”, | [1] |
| “LO_statement”: “Recall the method to erase a spatial anchor | [2] |
| from persistent storage.”, | |
| “content_source”: { | [3] |
| “markdown”: “spatial-anchor-overview.md”, | |
| “video”: “”, | |
| “code”; “” | |
| }, | [4] |
| “section_mapping”: { | [5] |
| “markdown_header”: [“## Erase a spatial anchor”, “”, “”], | |
| “video_segment”: { | |
| “start”: 0, | [6] |
| “end”: 0, | |
| }, | |
| “code_lines”: { | |
| “start”: 0, | |
| “end”: 0, | |
| }, | |
| }, | |
| }, | |
| ] ... | |
| } | |

In the second listing shown above, segments 1 through 6 are described in the following. [1] Defines a unique identifier: LO27. [2] Defines the LO statement: “Recall the method to erase a spatial anchor from persistent storage.” [3] Links to the content source where this LO maps, such as a markdown text. [4.] Is a text section titled “##Erase a spatial anchor.” [5] No video segments. [6] No code lines.

An alternative view of the same sample LO definition and its metadata is shown and described below in text form. The third listing provided below is the actual content that this LO maps into.

```
# unity-spatial-anchors-persist-content.md
...
## Erase a spatial anchor
Use the OVRSpatialAnchor.EraseAnchorAsync method to erase a spatial
anchor from persistent storage.
Example:
async void OnEraseButtonPressed ( )
{
  var result = await _spatialAnchor.EraseAnchorAsync( );
  if (result.Success)
  {
    Debug.Log($“Successfully erased anchor.”);
    }
  else
    {
    Debug.LogError($“Failed to erase anchor {_spatialAnchor.Uuid}
with result {result.Status}”);
    }
  }
```

The LO “Recall the method to erase a spatial anchor from persistent storage” acts as a direct proxy or abstraction for this content. This setup enables the content to be directly replaced by the LO for search purposes. The following fourth listing demonstrates how the search space is reduced.

# unity-spatial-anchors-persist-content.md
...
## Erase a spatial anchor

LO27: Recall the method to erase a spatial anchor from persistent storage.

The significant reduction in space for content representation is noticeable. A single LO statement encapsulates the entire content based on the author's intent, regardless of writing style, format, or details. The way this mapping improves the search is by searching against LOs instead of content as discussed herein with sample implementation.

A component of the subject disclosure includes a search against LOs instead of content, and a search for which LOs represent the author's intent instead of the actual content. This approach enables any search system to identify an LO as a single sentence representing a knowledge unit, rather than requiring it to locate an entire text section or content in other multimodal formats, such as video segments. The direct connection between an LO and the content it represents, through LO metadata, ensures accurate and current search results.

In the example below, the knowledge consumer is a human user querying for content on a website. There are approximately 2200 lines of content in markdown, including images, code snippets, and videos. The entire content can be written in markdown format similar to the third listing described above. The LOs representing this content are approximately 120, a few of them appearing in the fifth example listing shown below.

...
LO26: Explain the binding of a spatial anchor to an OVRSpatialAnchor
component.
LO27: Recall the method to erase a spatial anchor from persistent storage.
LO28: Describe the process of destroying a spatial anchor and its
implications on system resources.
LO29: Explain best practices for handling spatial anchors across different
rooms or floors.
...

In a sixth listing shown below LOs are mapped against the content.

# spatial-anchor-overview.md
...
# unity-spatial-anchors-persist-content.md
...
### Bind each spatial anchor to an OVRSpatialAnchor
LO26: Explain the binding of a spatial anchor to an OVRSpatialAnchor
component.
## Erase a spatial anchor
LO27: Recall the method to erase a spatial anchor from persistent storage.
## Destroy spatial anchors
LO28: Describe the process of destroying a spatial anchor and its
implications on system resources.
## How to handle spatial anchors from another room or floor?
LO29: Explain best practices for handling spatial anchors across different
rooms or floors.

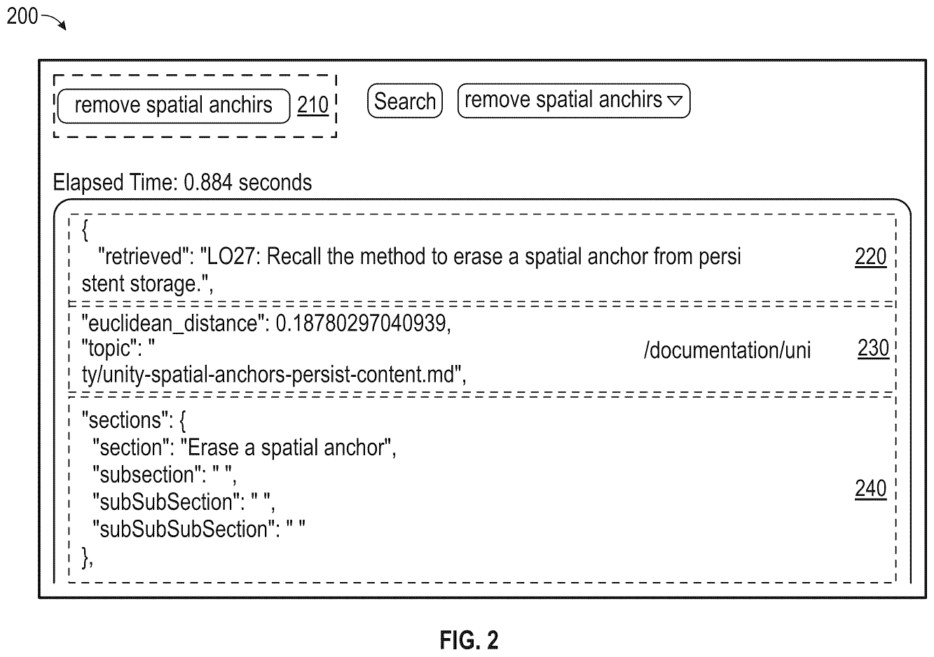

FIG. 2 is a diagram illustrating an example of a user experience prototype 200, in accordance with some aspects of the subject technology. The user experience prototype 200 includes user queries 210, search results 220, and steps 230 and 240. The user queries 210 includes “remove spatial anchirs.” This intentional misspelling demonstrates our approach's accuracy. The system uses this query to perform a semantic search against the set of LOs.

The search results 220 show “LO27: Recall the method to erase a spatial anchor from persistent storage” as the most relevant LO. Semantic search determines relevance by understanding the meaning and context of both the query and the LO representing the content. This can involve ranking based on semantic similarity, using techniques such as embeddings and nearest neighbor algorithms, or even basic Euclidean distances. The semantic search reveals no direct match for the “remove spatial anchor” LO. Instead, it finds an LO related to a programming method for “erasing” a spatial anchor, which is what the most relevant LO is about.

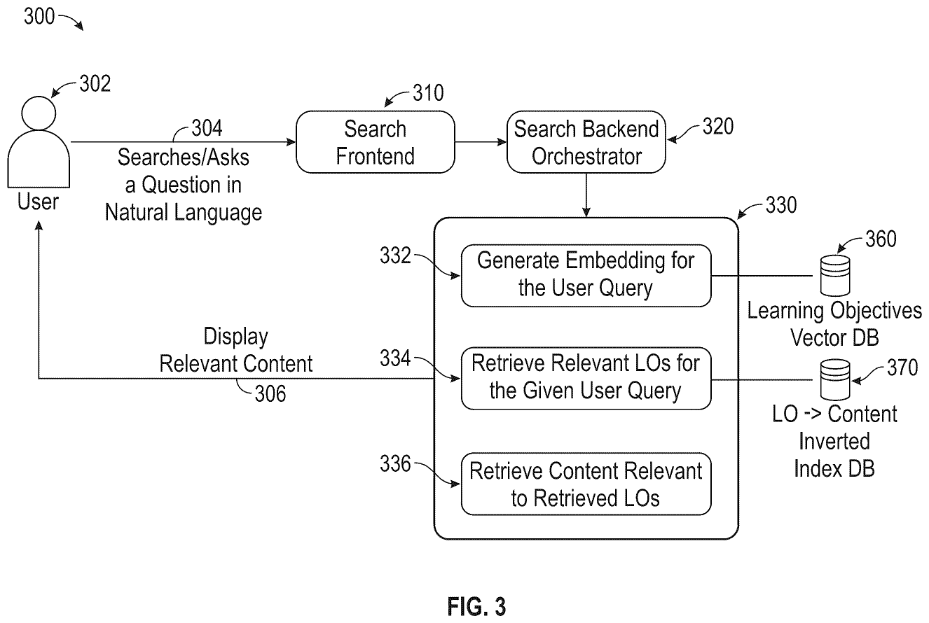

In step 230, the system works backwards from the LO metadata to identify where the relevant content is stored. In step 240, using this metadata, the system can also locate the intended content through metatags at the section level. The section's actual content is then seamlessly returned to the user, for example, similar to the third listing described above. An example system architecture related to this sample implementation system is illustrated below with respect to FIG. 3.

FIG. 3 is a block diagram illustrating an example system architecture 300 of an LO-based sematic search, in accordance with some aspects of the subject technology. The system architecture 300 includes a search frontend 310, a search backend orchestrator 320, an API 330, an LO objectives vector DB 360 (hereinafter, DB 360) and an LO-to-content inverted index DB 370 (hereinafter, DB 370). A user 302 can input a search query 304 (or a question asked in a natural language) through a basic interface. The search frontend 310 captures the search query 304 and sends it to the search backend orchestrator 320. The search backend orchestrator 320 is a system or component responsible for managing and coordinating the various processes involved in handling search queries and delivering search results. The search backend orchestrator 320 directs the query to the API 330 (or service) for semantic search. The API 330 executes steps 332, 334 and 336.

In step 332, embedding is generated for the specific user query using DB 360, which is a specialized type of vector database designed to store, manage, and retrieve LOs represented as vectors. A semantic search is then conducted on an LO vector store (vector DB) in vector form. This vector store may contain the LOs and their metadata, not the actual content mapped to LOs. As a result, it constitutes a significantly smaller search space. In step 334, the system retrieves the most relevant LOs from the DB 360 and searches the LO-content map database for these LOs. In step 336, the content linked to the relevant LOs is retrieved from the DB 370, which is a specialized type of inverted index designed to map LOs to the content that addresses them. The API 330 then responds with the relevant content 306 to the user's query and displays it to the user 302.

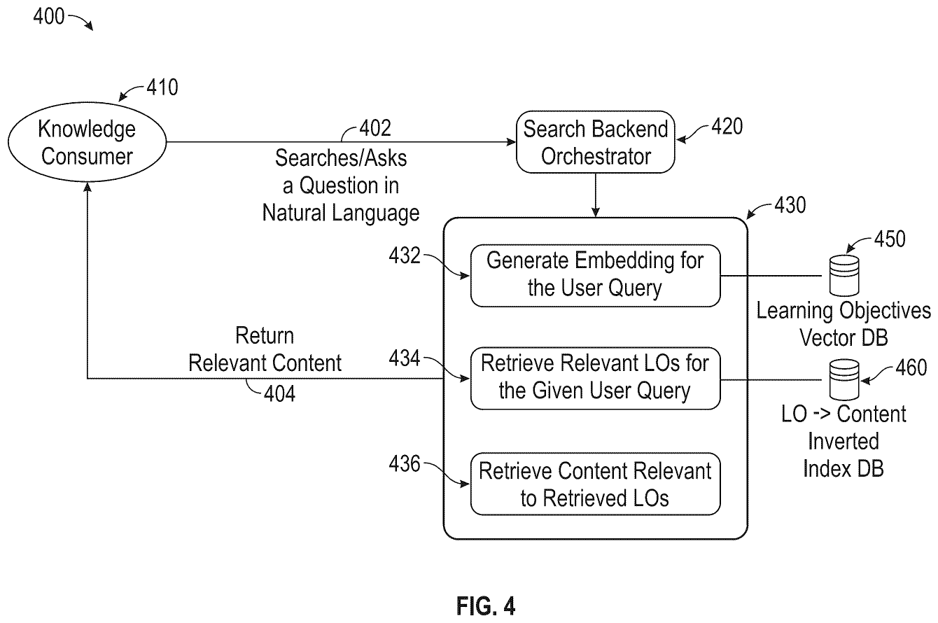

FIG. 4 is a block diagram illustrating an example of a system 400 for an LO-based sematic search for any knowledge consumer, in accordance with some aspects of the subject technology. The system 400 includes a search backend orchestrator 420, an API 430, an LO objectives vector DB 450 (hereinafter, DB 450) and an LO-to-content inverted index DB 460 (hereinafter, DB 460).

A knowledge consumer 410 accesses, interprets, and applies knowledge to make informed decisions or perform tasks. The knowledge consumer 410 may rely on knowledge producers (e.g., those who create and share knowledge) to provide accurate and relevant information. The knowledge consumer 410 inputs a search query 402 through a suitable mechanism, and the search frontend (not shown for simplicity) or any other suitable service captures the knowledge consumer's search query 402 and sends it to the search backend orchestrator 420. The search backend orchestrator 420 directs the query 402 to an API 430 (or service) for semantic search. The API 430 executes steps 432, 434 and 436.

In step 432, the embedding is generated for the specific knowledge consumer's query 402. A semantic search is then conducted on the DB 450, which contains the LOs and their metadata, not the actual content mapped to LOs. As a result, it constitutes a significantly smaller search space. In step 434, the most relevant LOs for the given user query 402 are retrieved from the DB 460. In step 436, the LO-content map database (not shown for simplicity) is searched for the relevant LOs and the content linked to these LOs is retrieved. The system outputs the content 404 relevant to the knowledge consumer's query 402 back to the knowledge consumer 410 (or to any other module of a bigger system).

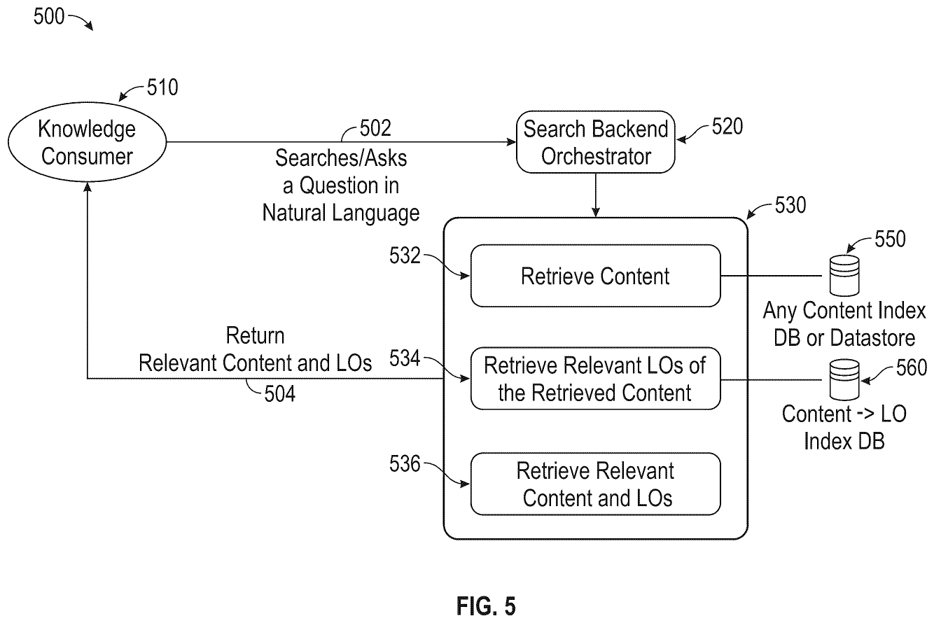

FIG. 5 is a block diagram illustrating an example of a sample search system 500 capable of outputting LOs for any knowledge consumer, in accordance with some aspects of the subject technology. The system 500 includes a search backend orchestrator 520, an API 530, a content index DB 550 (hereinafter, DB 550) and a content-to LO index DB 560 (hereinafter, DB 560).

The knowledge consumer 510 inputs a search query 502 (or a question asked in a natural language) through a suitable mechanism, and the search frontend (not shown for simplicity) or any other suitable service captures the knowledge consumer's search query 502 and sends it to the search backend orchestrator 520. The search backend orchestrator 520 directs the query 502 to an API 530 (or service) for semantic search. The API 530 executes steps 532, 534 and 536.

In step 532, the search typically retrieves relevant indexed content from the DB 550. The system uses the map between this content to the actual LOs through metadata, such as links and sections. In step 534, the most relevant LOs tied to the content are retrieved from the DB 560. In step 536, a query output is formed by the combination of content and LOs. The system then delivers the relevant content and LOs 504 back to the knowledge consumer 510 or another module in a larger system. Search queries can target either LOs or content, if there is a mapping between them. The fifth and sixth listings described above illustrate examples of this mapping, which is crucial for the recommendation components of the disclosed solution.

The rest of the description herein details how the relationship between LOs creates an adaptive learning system for any knowledge consumer. The LOs map against content in any format, acting as an abstraction for knowledge construction. Thus, finding or referring to an LO implies accessing the actual content, regardless of its format.

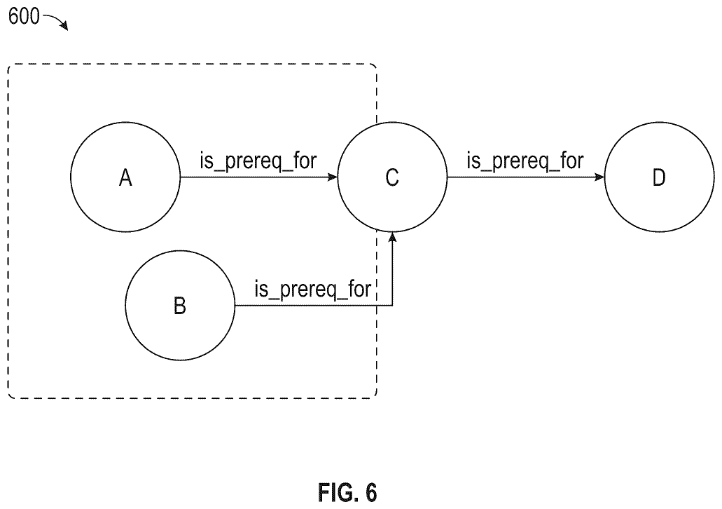

The LOs create nodes in an acyclic knowledge dependency graph. Directional edges between these nodes show knowledge dependencies. For any knowledge consumer, a “is a prerequisite for” relationship is essential to understand or apply a fact, concept, or procedure. FIG. 6 provides an example.

FIG. 6 is a schematic diagram illustrating an example of an LO graph 600, in accordance with some aspects of the subject technology. The LO graph 600 is an example of an acyclic knowledge dependency graph, which includes nodes created by LOs and directional edges between these nodes showing knowledge dependencies. For any knowledge consumer, a “is a prerequisite for” relationship represents knowledge dependency between two LOs and is used to denote what they must understand or apply as a fact, concept, or procedure before moving further.

In the example LO graph 600, LOs A, B, C, and D are shown as nodes (ellipses). Each LO is already mapped to multimodal content. LO C has LOs A and B as prerequisites. To remember, understand, or apply LO C and its content, a knowledge consumer first grasps LOs A and B. These are hard prerequisites for consuming the LO C. LO C is also a prerequisite for LO D, meaning LO D has LO C as a prerequisite. In that sense, it is impossible to fully grasp LO D, without really remembering, knowing, or being able to apply LOs A, B, and C.

The concept of knowledge relationships, both empirically and formally, has long been used. This foundational idea underpins the disclosed approach. These relationships are believed to be objectively existing for many knowledge consumers in different contexts.

Metaphorically, this concept applies to various contexts, such as cooking. For example, to prepare a ragu sauce, one must first understand how to prepare sofrito and how to chop its ingredients properly. In turn, this requires knowing how to use a knife safely. Understanding foundational concepts is essential before advancing to complex topics, just as basic culinary techniques are necessary for cooking a dish like ragu.

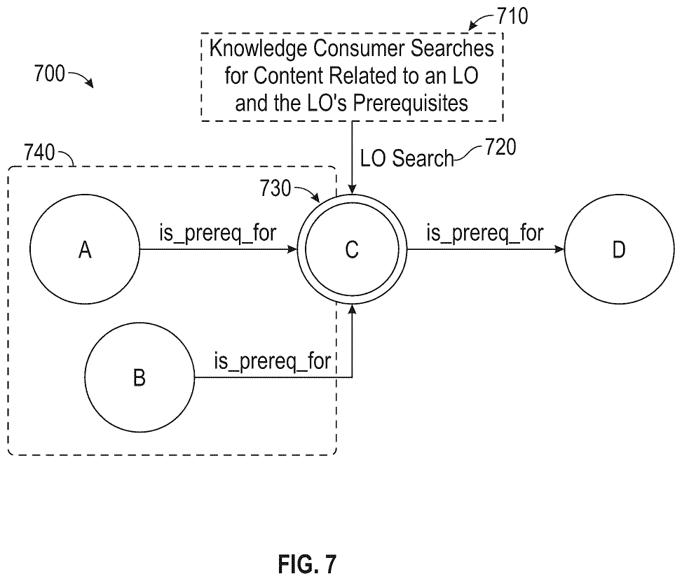

FIG. 7 is a schematic diagram illustrating an example of an LO graph 700 and a prerequisite search, in accordance with some aspects of the subject technology. The LO graph 700 describes an important application of the search system combined with a graph. Given the LO graph 700, the mapping between LOs and content, and the previously described search system on LOs, any knowledge consumer can objectively identify the prerequisites for any returned LO or content, as described herein. The LO graph 700 includes a step 710 where a knowledge consumer queries for relevant content, an LO search 720, an LO 730 (LO C) and prerequisites 740. The knowledge consumer queries for relevant content related to an LO 730 and prerequisites 740. The LO search 720 is conducted as described above in paragraphs 47 and 48 (search against LOs instead of content). This module is foundational for all subsequent searches. The system outputs the relevant LO 730. Additionally, because LO 730 exists in the LO graph 700, it also outputs its prerequisites 740, including LOs A and B.

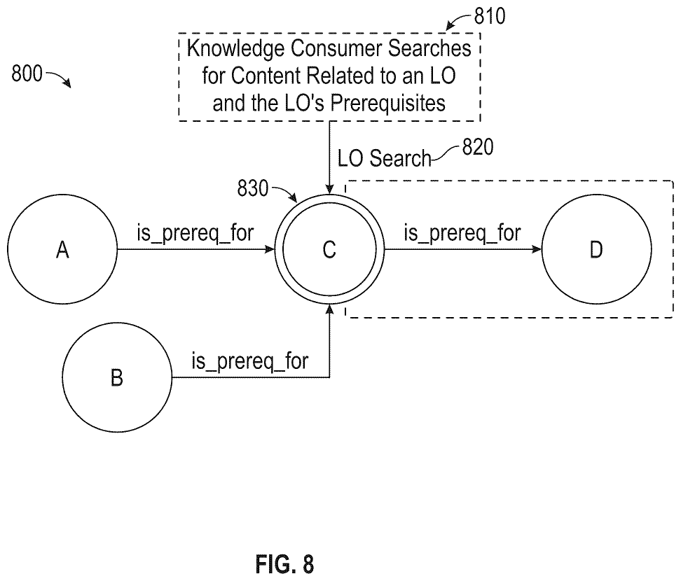

Knowledge consumers can objectively identify the knowledge pieces they can access after completing LO 730, as shown and discussed below with respect to FIG. 8. The LO graph may guarantee that if LO 730 is a prerequisite for other LOs (e.g., LO D), these can also be displayed to the knowledge consumer. These constitute a corpus of LOs (thus, content) of what's next in the knowledge consumer's learning journey.

FIG. 8 is a schematic diagram illustrating an example of a graph 800 of an LO search and a what's next search, in accordance with some aspects of the subject technology. The LO search and a what's next search shown in graph 800 includes a step 810 where the knowledge consumer queries for relevant content as described above. In the next step 820, the LO search is performed similarly. Next, the system outputs the relevant LO 830 (LO C). Since LO 830 is part of an LO knowledge dependency graph, it also outputs the LOs for which it is a prerequisite, such as LO D in this example. One fundamental application of this mechanism is that the knowledge consumer can objectively retrieve content related to an output LO, along with all LOs the output LO depends on or serves as a prerequisite for.

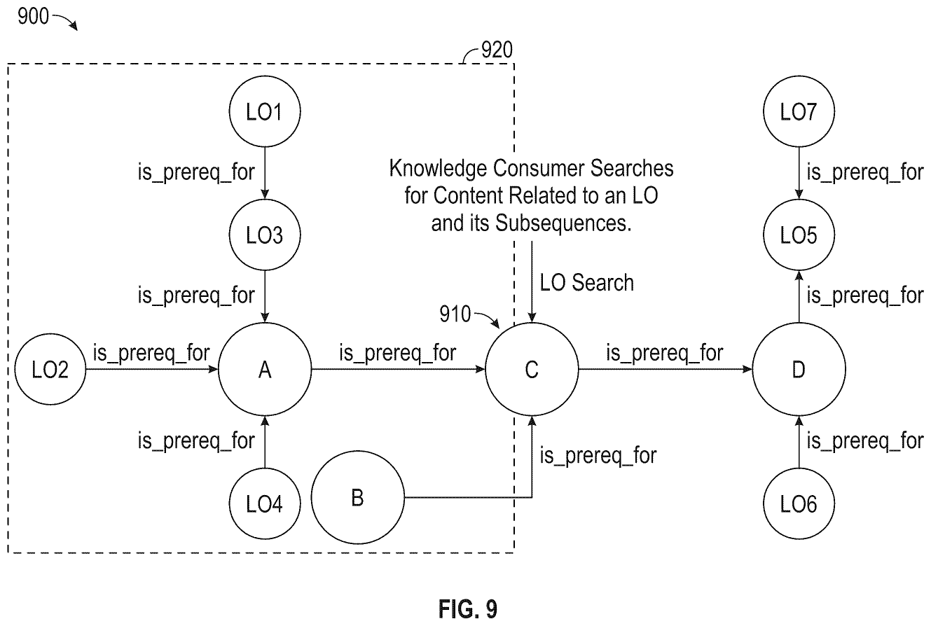

Additionally, the knowledge consumer can access all nodes that depend directly or indirectly on this output LO, or the prerequisite LOs for the output LO. This forms the basis of a global learning journey, one that is suitable for all knowledge consumers, as shown and described below with respect to FIG. 9.

FIG. 9 is a schematic diagram illustrating an example of a graph 900 for an LO search and a prerequisite learning journey, in accordance with some aspects of the subject technology. The graph 900 indicates that the disclosed system returns the output LO 910 (LO C). The disclosed system returns the LOs 920 that include prerequisites (A and B) of the output LO 910, as well as the entire sequence of dependencies for these prerequisite LOs (LOs 1, 2, 3, and 4). This allows any set of LOs and the topological order in which they are to be consumed in reverse to maintain knowledge dependencies and be automatically accessible through the LO graph prerequisites. A well-documented algorithm to achieve this is a depth-first search (DFS) graph traversal. The algorithm should operate based on a threshold. This threshold can be the number of LOs to display or the path length (distance) between the output LO and the last LO to display. Consequently, the logical sequence for the knowledge consumer to learn the output LO 910 is to first ensure they recall, understand, or can apply the content associated with LOs B, 2, 1, 3, 4, and A (in that or a similar order).

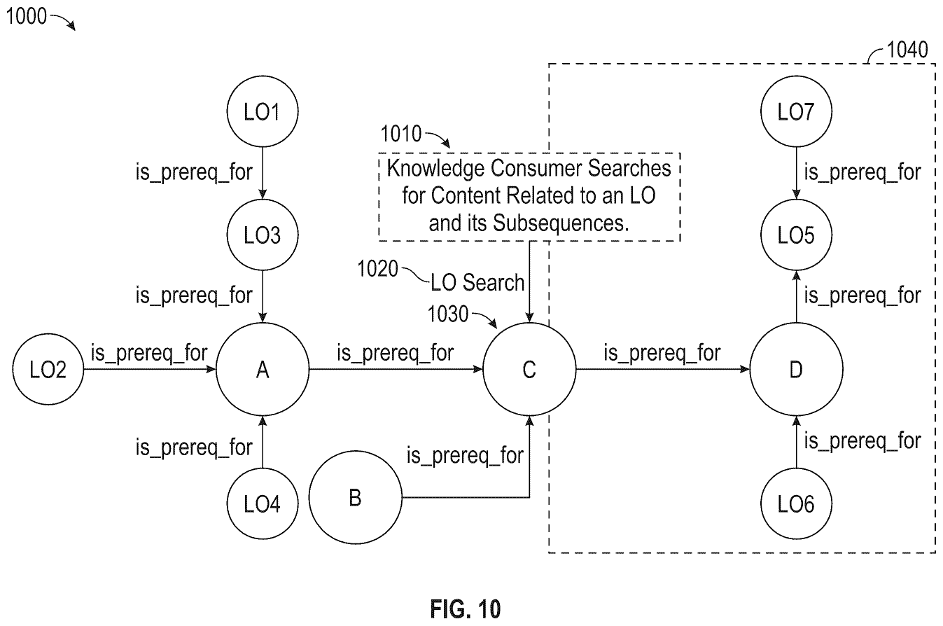

The content mapped to all prerequisite LOs forms an objective prerequisite corpus for any knowledge consumer based on a query in the search system. Similarly, if a knowledge consumer wants to know what they can learn after the output LO 910, the mechanism highlights the LOs for which the output LO 910 is a prerequisite, along with their dependencies. FIG. 10 illustrates this with an example.

FIG. 10 is a schematic diagram illustrating an example graph 1000 of an LO search and a subsequent learning journey, in accordance with some aspects of the subject technology. The graph 1000 includes a step 1010 where a knowledge consumer queries for relevant content, an LO search 1020, an output LO 1030 (LO C) and the LOs 1040 for which output LO C is a prerequisite. The system returns the LOs 1040, such as LO D. It also provides the entire sequence of dependencies for these subsequent LOs, including LOs 5, 6, and 7. Therefore, after output LO 1030, the logical learning sequence for the knowledge consumer is to first recall, understand, or apply the content of LOs 6, D, 7, and 5, in that or a similar order. An algorithm to achieve this is the DFS algorithm, which efficiently traverses the graph to identify and order these dependencies. The algorithm can operate based on a threshold, which can be the number of LOs to display or the path length (distance) between the output LO and the last LO to display.

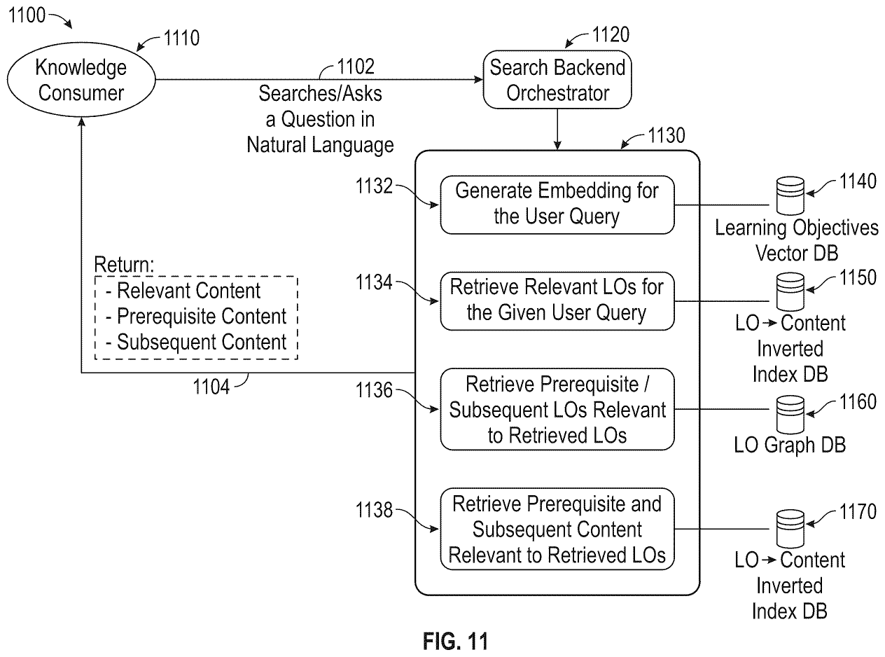

FIG. 11 is a schematic diagram illustrating an example of a system 1100 for an LO search and an objective journey, in accordance with some aspects of the subject technology. The system 1100 includes a search backend orchestrator 1120, an API 1130, a learning objectives vector DB 1140 (hereinafter, DB 1140), an LO-to-content inverted index DB 1150 (hereinafter, DB 1150), an LO graph DB 1160 (hereinafter, DB 1160) and an LO-to-content inverted index DB 1170 (hereinafter, DB 1170).

The knowledge consumer 1110 inputs a search query 1102 (or a question asked in a natural language) through a suitable mechanism, and the search frontend (not shown for simplicity) or any other suitable service captures the knowledge consumer's search query 1102 and sends it to the search backend orchestrator 1120. The search backend orchestrator 1120 directs the query 1102 to an API 1130 (or service) for semantic search. The API 1130 executes steps 1132, 1134, 1136 and 1138.

In step 1132, using the DB 1140, embedding for the user query 1102 is generated. In step 1134, relevant LOs for the given user query 1102 are retrieved from the DB 1150. In step 1136, after retrieving the relevant output LO, a depth-first search is conducted on the DB 1160. This search retrieves all the prerequisites, subsequent LOs, and entire learning journeys. In step 1138, a new search is performed on the DB 1170 to obtain content associated with the prerequisite and subsequent learning journeys.

The output 1104 of the API 1130 available to the knowledge consumer 1110 includes not only the content around the output LO, based on a search query, but also the logical order in which prerequisite and subsequent content should be consumed to maintain knowledge dependencies and consistency.

For the step 1136, given a graph, the general LO metadata pattern in plain JSON format as illustrated in the first listing described above, converts to the following listing (seventh listing):

```
{
    ″learning_objectives″: [
    {
      ″id″: ″Unique id of LO″,
      ″LO_statement″: ″LO statement in natural language″,
        ″content_source″: {
...
      },
      ″section_mapping″: {
        ″markdown_header″: [″Section, ″Subsection″, ″Subsubsection″,
        ...],
        ″video_segment″: {
          ″start″: starting_point_in_sec,
          ″end″: ending_point_in_sec
        },
      “code_lines”: {
        “start= ”: code_line_start,
        “end”: code_line_end
    },
...
    },
    “is_prereq_for”: [“prerequisite_LO1”, ...],
  },
] ...
}]
```

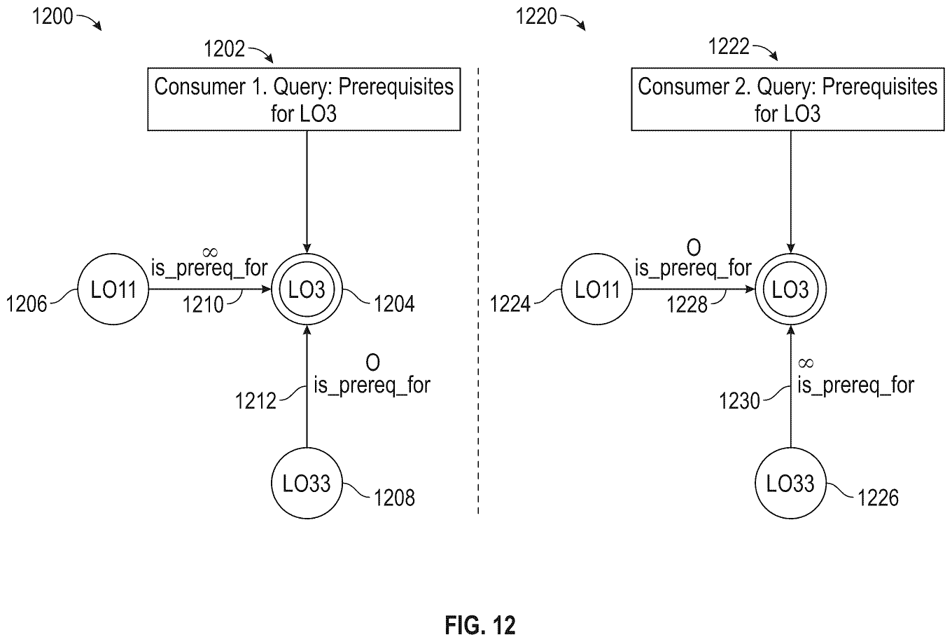

FIG. 12 is a schematic diagram illustrating examples of graphs 1200 and 1220 of personalized edge weights for individual knowledge consumers, in accordance with some aspects of the subject technology. The graphs 1200 and 1220 are related to two queries of different consumers, for example, consumer 1 and consumer 2. The prerequisites for both queries are the same, but the edge weights are different, as explained herein.

Implementing graph 1200 includes steps 1202, 1204, 1206, 1208, 1210 and 1212. In step 1202, the knowledge consumer 1 searches for content related to LO3 and also requests its prerequisite content. In step 1204, the search system retrieves LO3 and its related content, as described above in paragraphs 47 and 48 (search against LOs instead of content). In step 1206, a query in the LO graph database reveals that LO11 is a prerequisite for LO3. The following are assumptions made. A) Knowledge consumer 1 studied the content mapped to LO11 either 10 minutes ago in this current session or 20 hours ago in a previous session. B) The system knows this because it tracks all visited nodes for each knowledge consumer. C) This requires a database of visited nodes, stored either locally or centrally by the system provider. D) A simple query to this database, using the LO (node) ID if stored locally, or the consumer's ID and the LO (node) ID if stored centrally, retrieves the information. The system functions the same way in both cases.

In step 1208, it is revealed that LO3 has a second prerequisite, LO33. The assumptions here are: A) the knowledge consumer has never interacted with the content mapped to LO33 and B) confirming this requires a query to a database of all visited nodes per consumer.

In step 1210, for the edge connecting LO3 and LO11, the system assigns an infinite edge weight for knowledge consumer 1 because LO11 was recently visited. The system retrieves this unique value for consumer 1 by querying a database, stored either locally or centrally.

In step 1212, for the edge connecting LO3 and LO33, the system assigns an edge weight of 0 for knowledge consumer 1 because LO33 was never visited. The assumptions made include: B) assume the system retrieves this unique value for consumer 1 by querying a database, stored either locally or centrally, and C) for simplicity, assume the system only assigns one of two values, 0 or infinity, based on whether the content (LO) was ever consumed in current and/or previous sessions by the same consumer.

Implementing graph 1220 includes steps 1222, 1224, 1226, 1228, and 1230. In step 1222, the knowledge consumer 2 asks the same query about LO3 and its prerequisites. The same prerequisite LOs appear, such as LO11. In step 1224, it is assumed here that consumer 2 has never visited LO11. In step 1226, the second prerequisite LO for LO3 is found to be LO33. In step 1228, based on the assumption in step 1224, the edge weight for the edge connecting LO3 and LO11 is assigned to 0. In step 1230, conversely, the edge weight for the edge connecting LO3 and LO33 is infinite.

To summarize this concept, for the same query, both consumer 1 and consumer 2 receive output for LO3. However, consumer 1 is notified by the system to study content mapped to LO33 (which they have never visited before). Optionally, they may be informed that they have already consumed content mapped to LO11, depending on the implementation. Conversely, consumer 2 is notified by the system to study content mapped to LO11 (which they have never visited before). Optionally, they may be informed that they have already consumed content mapped to LO33, depending on the implementation. The concept disclosed herein underpins the subject personalized search system. All consumers use the same graph, but edge weights vary and are unique per consumer based on their individual prior knowledge consumption, stored either centrally or locally per consumer. Note that listing an LO as visited rather than just browsed for human knowledge consumers requires specific user-interface (UI) guardrails and telemetry.

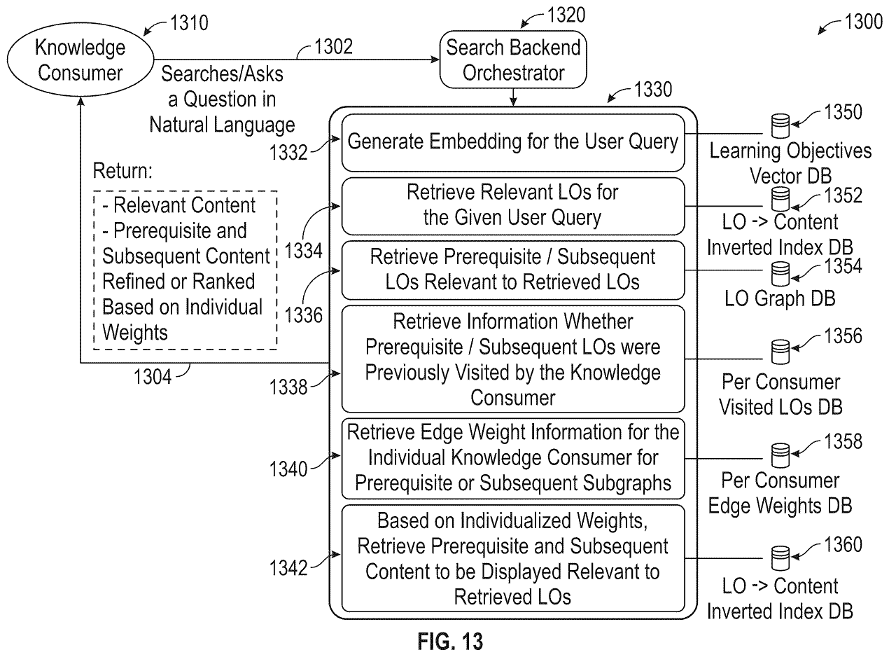

FIG. 13 is a schematic diagram illustrating an example of a system 1300 for an LO search and individualized prerequisites, in accordance with some aspects of the subject technology. The system 1300 includes a search backend orchestrator 1320, an API 1330, a learning objectives vector DB 1350 (hereinafter, DB 1350), an LO-to-content inverted index DB 1352 (hereinafter, DB 1352), an LO graph DB 1354 (hereinafter, DB 1354), a per-consumer visited LOs DB 1356 (hereinafter, DB 1356), a per-consumer edge weights DB 1358 (hereinafter, DB 1358) and an LO-to-content inverted index DB 1360 (hereinafter, DB 1360).

The knowledge consumer 1310 inputs a search query 1302 (or a question asked in a natural language) through a suitable mechanism, and the search frontend (not shown for simplicity) or any other suitable service captures the knowledge consumer's search query 1302 and sends it to the search backend orchestrator 1320. The search backend orchestrator 1320 directs the query 1302 to an API 1330 (or service) for semantic search. The API 1330 executes a number of steps including steps 1332, 1334, 1336, 1338, 1340 and 1342.

The steps 1332, 1334 and 1336 are respectively similar to the steps 1132, 1134 and 1136 of FIG. 11 and are not repeated herein for brevity. In step 1338, using the DB 1356, information on whether the prerequisite or subsequent LOs have been previously visited by the knowledge consumer is retrieved. This feature is optional, as the individualized edge weights alone can provide sophisticated signals for knowledge consumption based on the implementation, however, it may be useful depending on the use case.

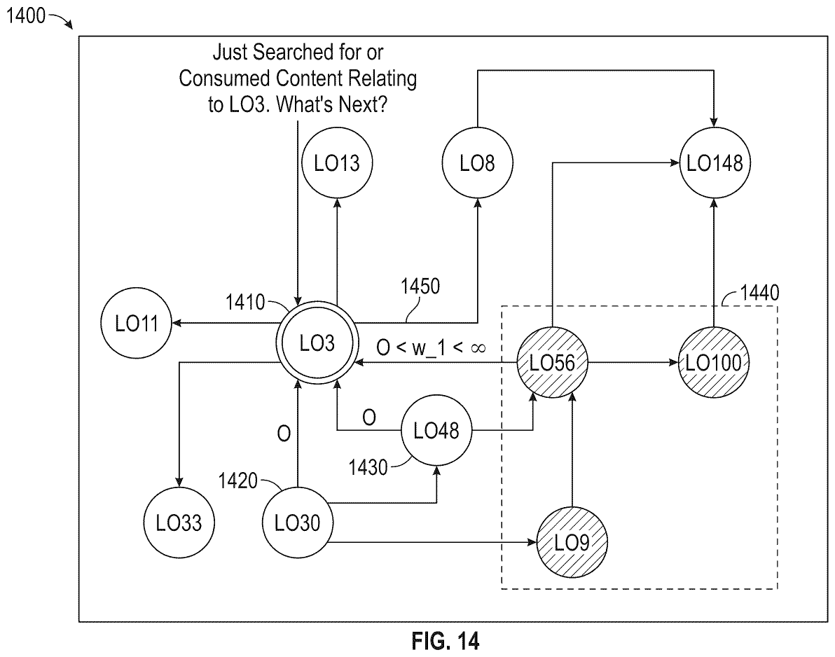

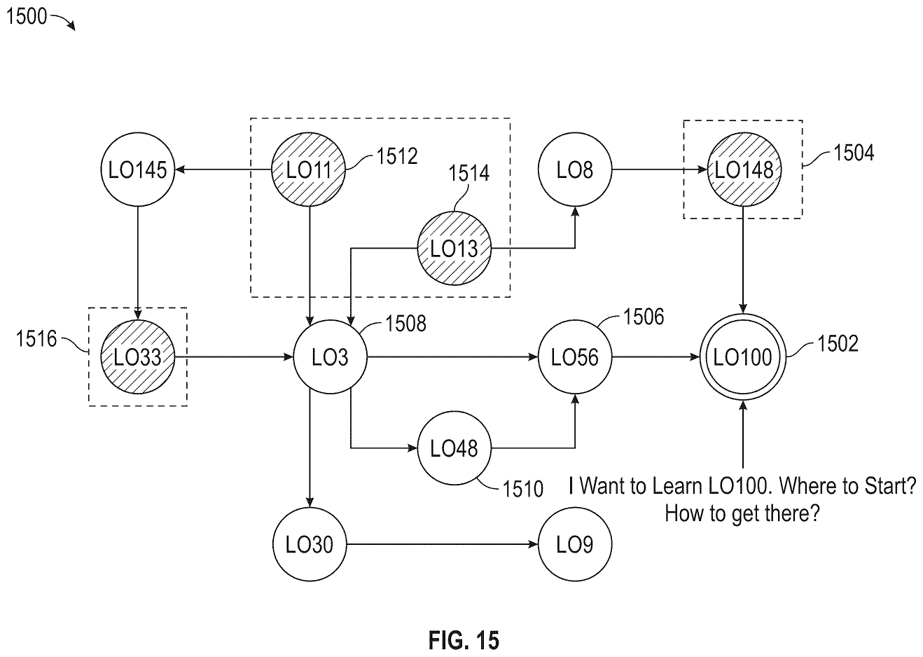

In step 1340, the individual consumer's edge weight information relevant to the subgraphs formed by prerequisite or subsequent LOs is retrieved from DB 1358 (e.g., a central database or a local data store specific to the individual knowledge consumer). Depending on the use case, some of the algorithms are outlined below with respect to FIGS. 14 and 15.

In step 1342, the relevant content for the identified prerequisite or subsequent LOs is retrieved from DB 1360. The relevant content 1304, along with the content of the queried and/or output LO, is then returned to the knowledge consumer 1310.

FIG. 14 is a schematic diagram illustrating an example graph 1400 of an algorithm for a personalized search, in accordance with some aspects of the subject technology. The algorithm for the personalized search determines the next recommendation and/or ranking. For a knowledge consumer who has searched for, or consumed content related to a specific output LO, the main task is to rank the LOs that depend on this output LO using individual edge weights. If the consumer has just engaged with an LO, the question would be which subsequent LO and its associated content they must explore next. FIG. 14 illustrates an example where all edges indicate “is a prerequisite for” and some nodes are previously visited by the consumer. The algorithm 1400 includes steps 1410, 1420, 1430, 1440 and 1450. Note that LOs surrounded by dash lines are determined to be previously visited by the consumer.

In step 1410, LO3 is determined to be either the search output LO or the LO recently consumed by the knowledge consumer. In step 1420, it is determined that LO3 is a prerequisite for LO30, which the consumer has never visited. The edge connecting these two LOs has a weight of 0. In step 1430, it is determined that LO3 is also a prerequisite for LO48, which is also unvisited. The edge connecting these two LOs has a weight of 0. In step 1440, LO3 is found to be a prerequisite for LO56, which the consumer has already visited before. The weight connecting LO3 and LO56 is between 0 and infinity (or normalized between 0 and 1), depending on factors discussed in the description of FIG. 12 with regard to individual edge weight calculation. Therefore, the recommendation system has to rank the next LOs for LO3 as LO30, LO48, and LO56. The content returned to the knowledge consumer should be tied to these LOs in that order, which is topological order of these nodes.

At an algorithmic level, the following pseudocode in the listing below (referred to as the eighth listing) generalizes this solution by ranking of dependent LOs, given any LO in the graph and individual edge weights.

```
Algorithm order_dependent_los(current_lo)
Input: current_lo (the current LO)
Output: ordered_los (ordered list of dependent LOs)
Initialize dependent_los as an empty list
For each dependent_lo in get_dependent_los(current_lo) do
      weight = get_edge_weight(current_lo, dependent_lo)
      Add (dependent_lo, weight) to dependent_los
Sort dependent_los by weight in ascending order
Initialize ordered_los as an empty list
For each (lo, weight) in dependent_los do
      Add lo to ordered_los
Return ordered_los
// Helper: Use DFS with threshold to find dependent LOs to current_lo
Algorithm order_prerequisite_los(target_lo)
Input: target_lo (the target LO)
Input: depth_threshold (how deep we can go)
Input: weight_threshold (at what weight we should stop considering LOs
as candidates)
Output: ordered_prerequisite_los (ordered list of prerequisite LOs)
initialize solution_list as empty list
call order_prerequisite_los(lo: current_lo, weight: 0, depth: 0)
order_prerequisite_los(lo, weight, depth)
    if depth is within threshold
  prerequisite_los = get_prerequisite(lo) as a list
  for each prerequisite_lo in prerequisite_los do
    if prerequisite_lo is not already in solution_list
      prerequisite_weight = get_edge_weight(lo, prerequisite_lo)
        if prerequisite_weight is within weight_threshold
          order_prerequisite_los(
            prerequisite_lo,
            prerequisite_weight,
            depth+1)
  add (lo, weight) to solution_list
perform topological sort ordered by weight in ascending order on
solution_list
```

Another algorithm (referred to as the second algorithm) discussed herein relates to prerequisites ranking and recommendation. This algorithm ranks prerequisite LOs for a given LO by identifying and ordering the LOs that must be understood first. This order is important because prerequisite LOs might be new to the learner or recently reviewed. Since edge weights are dynamically calculated for each knowledge consumer, the output is a ranked set of LOs and their corresponding content, ensuring seamless knowledge gap filling. The following listing (referred to as the ninth listing) showcases the algorithm for ranking of prerequisite LOs, given any LO in the graph and individual edge weights.

```
Algorithm order_prerequisite_los(target_lo)
Input: target_lo (the target LO)
Output: ordered_prerequisite_los (ordered list of prerequisite LOs)
Initialize prerequisite_los as an empty list
For each prerequisite_lo in get_prerequisite_los(target_lo) do
  weight = get_edge_weight(prerequisite_lo, target_lo)
  Add (prerequisite_lo, weight) to prerequisite_los
Sort prerequisite_los by weight in ascending order
Initialize ordered_prerequisite_los as an empty list
For each (lo, weight) in prerequisite_los do
  Add lo to ordered_prerequisite_los
Return ordered_prerequisite_los
```

The third algorithm is an objective determination of LOs to visit to reach a target LO. In this scenario, a knowledge consumer is searching for a target LO and needs to identify all the LOs they must visit, based on their previously consumed LOs. For simplicity, the following approach focuses on the list of visited LOs per consumer, rather than considering edge weights; thus, it is not optimized in terms of personalization. An example implementation of this algorithm is shown and discussed below with respect to FIG. 15.

FIG. 15 is a schematic diagram illustrating an example graph 1500 of an algorithm for objective determination of LOs to visit to reach a target LO, in accordance with some aspects of the subject technology. The algorithm represented by the graph 1500 includes steps 1502, 1504, 1506, 1508, 1510, 1512, 1514 and 1516. Note that LOs surrounded by dash lines are determined to be previously visited.

In step 1502, the search system retrieves LO100 based on the consumer's query. In step 1504, starting from LO100, the system follows the inverted edge connecting prerequisite LOs to the target LO. The first one is LO148. Since it was visited before, this LO is not recommended to the consumer. In step 1506, the next LO is LO56, which has never been visited before. Therefore, LO56 is recommended to the consumer. In step 1508, continuing from LO56, LO3 is an unvisited prerequisite, so it will also be returned to the knowledge consumer. Similarly, in step 1510, LO48 is returned to the consumer. In step 1512, starting from LO3, LO11 is a previously visited prerequisite and would not be returned as output. LO48 has no other prerequisites except LO3, which is already on the list. Similarly, in step 1514, LO13 is a previously visited prerequisite and would not be returned as output. In step 1516, similarly, LO33 would not be returned as output.

This is an implementation of the breadth-first search algorithm. The inverted list of LOs retrieved with this algorithm (ordered as LO3, LO48, LO56) is the LOs (and the content mapped to them) that are used by the knowledge consumer to learn the target LO, given prior engagement with the system.

The next algorithm (referred to as the fourth algorithm) is used for personalized determination of LOs to visit to reach a target LO. Individual edge weights significantly enhance this approach, offering multiple effective ways to improve the results through various implementations. An indicative algorithm follows.

Instead of ending the algorithm when there are no other nodes to be listed between the target LO and all the closest visited LOs, the algorithm can continue running even after all the previously visited LOs are reached. It can proceed until it meets a certain threshold on all edge weights for LOs to be retrieved (breadth). This approach provides greater certainty in identifying the actual starting point of the inverse learning path. The edge weights, reflecting the knowledge consumer's journey, help determine where the learning path should begin, rather than relying solely on the LOs themselves. A sample algorithm for weighted personalized determination of all the LOs to visit for reaching a target LO follows in the listing below (referred to as the tenth listing).

```
Algorithm personalized_los_based_on_target(target_lo,
weight_threshold)
Input: target_lo (the target LO), weight_threshold (the minimum edge
weight to consider)
Output: ordered_prerequisite_los (ordered list of prerequisite LOs)
Initialize queue as an empty queue
Initialize visited_los as an empty set
Initialize ordered_prerequisite_los as an empty list
Enqueue target_lo into queue
While queue is not empty do
  Dequeue current_lo from queue
For each prerequisite_lo in get_prerequisite_los(current_lo) do
  weight = get_edge_weight(prerequisite_lo, current_lo)
If prerequisite_lo not in visited_los and weight <= weight_threshold then
  Add prerequisite_lo to visited_los
  Enqueue prerequisite_lo into queue
  Add prerequisite_lo to ordered_prerequisite_los
Return ordered_prerequisite_los
```

Next, personalized learning paths without target LO are considered. One of the benefits of the disclosed system is that it is highly personalized for a knowledge consumer. It functions even without direct knowledge consumer search query as input. Instead, it uses prior interactions of the knowledge consumers with the system as input. The output can be unique learning paths, which are sequences of LOs mapped to their content, tailored specifically for each knowledge consumer. This functionality is based on the individual edge weights (and in more complex scenarios, on other factors relating to clusters of LOs as nodes of the graph). A sample algorithm to achieve the simplest scenario is an individualized learning path generation. Important components (steps) of this algorithm include LO_sources, candidate LOs, backward exploration, and weight optimization steps. The LO_sources component begins with recently completed LOs, or in general, with LOs of smaller weight. In the candidate LOs step, LOs that lead to the LO sources are identified. These are the initial candidate LOs. The backward exploration step continues identifying LOs that lead to current candidate LOs, expanding the candidate set until reaching a specified depth, such as three levels deep. In the path building step, paths from candidate LOs are constructed, considering each path's total weight. In the weight optimization step, weights are used to prioritize paths. Weights are minimized to focus on recent learning (exploration mode) or maximized to revisit older content (revision mode). A sample listing (referred to as the eleventh listing) for this algorithm is provided below.

```
Algorithm generate_learning_paths(user_lo_graph, levels_deep,
optimize_for)
Input: user_lo_graph (graph of user's LOs), levels_deep (depth
threshold),
Optimize_for (minimize or maximize weights)
Output: learning_paths (list of candidate paths)
Initialize candidate_los as an empty set
Initialize learning_paths as an empty list
Collect all recently completed LOs as LO_sources
for each lo_source in LO_Sources do
  Initialize queue as an empty priority queue sorted by total_weight
  Enqueue (lo_source, 0, [lo_source]) into queue
While queue is not empty and current_depth < levels_deep do
  Dequeue (current_lo, total_weight, path) from queue
  If current_lo has dependencies not in path then
    For each dependency in get_dependencies(current_lo) do
      If dependency not in path and dependency not in LO_Sources then
        edge_weight = get_edge_weight(dependency, current_lo)
        new_total_weight = total_weight + edge_weight
        new_total_weight = total_weight + edge_weight
        new_path = path + [dependency]
        Enqueue (dependency, new_total_weight, new_path) into
        queue
  Else
    Add path to learning_paths
  If optimize_for is “minimize” then
  Sort learning_paths by total_weight in ascending order 26
Else if optimize_for is “maximize” then
  Sort learning_paths by total_weight in descending order
  Return learning_paths.
```

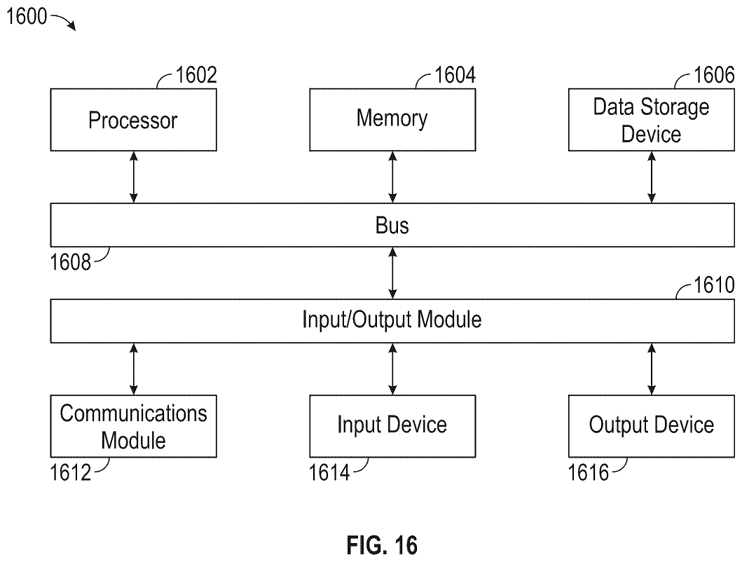

FIG. 16 is a diagram illustrating an example of a computer system within which some aspects of the subject technology are implemented. In certain aspects, the computer system 1600 may be implemented using hardware or a combination of software and hardware, either in a dedicated server, integrated into another entity, or distributed across multiple entities.

Computer system 1600 (e.g., server and/or client) includes a bus 1608 or other communication mechanism for communicating information, and a processor 1602 coupled with bus 1608 for processing information. By way of example, the computer system 1600 may be implemented with one or more processors 1602. Processor 1602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1600 can include, in addition to hardware, code that creates an execution environment for the computer program in question, e.g., code that constitutes processor firmware, a protocol stack, a database management system, an operating system, or a combination of one or more of them stored in an included memory 1604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1608 for storing information and instructions to be executed by processor 1602. The processor 1602 and the memory 1604 can be supplemented by, or incorporated in, special purpose logic circuitry.

The instructions may be stored in the memory 1604 and implemented in one or more computer program products, i.e., one or more modules of computer program instructions encoded on a computer-readable medium for execution by, or to control the operation of, the computer system 1600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1604 may also be used for storing temporary variable or other intermediate information during execution of instructions to be executed by processor 1602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1600 further includes a data storage device 1606 such as a magnetic disk or optical disk, coupled to bus 1608 for storing information and instructions. Computer system 1600 may be coupled via input/output module 1610 to various devices. The input/output module 1610 can be any input/output module. Exemplary input/output modules 1610 include data ports such as USB ports. The input/output module 1610 is configured to connect to a communications module 1612. Exemplary communications modules 1612 include networking interface cards, such as Ethernet cards and modems. In certain aspects, the input/output module 1610 is configured to connect to a plurality of devices, such as an input device 1614 and/or an output device 1616. Exemplary input devices 1614 include a keyboard and a pointing device, e.g., a mouse or a trackball, by which a user can provide input to the computer system 1600. Other kinds of input devices 1614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1616 include display devices such as an LCD (liquid crystal display) monitor, for displaying information to the user.

According to one aspect of the present disclosure, the above-described algorithms can be implemented using a computer system 1600 in response to processor 1602 executing one or more sequences of one or more instructions contained in memory 1604. Such instructions may be read into memory 1604 from another machine-readable medium, such as data storage device 1606. Execution of the sequences of instructions contained in the main memory 1604 causes processor 1602 to perform the process steps described herein. One or more processors in a multi-processing arrangement may also be employed to execute the sequences of instructions contained in memory 1604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1600 can include clients and servers. A client and server are generally remote from each other and typically interact through a communication network. The relationship of client and server arises by virtue of computer programs running on the respective computers and having a client-server relationship to each other. Computer system 1600 can be, for example, and without limitation, a desktop computer, laptop computer, or tablet computer. Computer system 1600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1602 for execution. Such a medium may take many forms, including, but not limited to, non-volatile media, volatile media, and transmission media. Non-volatile media include, for example, optical or magnetic disks, such as data storage device 1606. Volatile media include dynamic memory, such as memory 1604. Transmission media include coaxial cables, copper wire, and fiber optics, including the wires that comprise bus 1608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1600 reads application data and provides an application, information may be read from the application data and stored in a memory device, such as the memory 1604. Additionally, data from the memory 1604 servers accessed via a network, the bus 1608, or the data storage 1606 may be read and loaded into the memory 1604. Although data is described as being found in the memory 1604, it will be understood that data does not have to be stored in the memory 1604 and may be stored in other memory accessible to the processor 1602 or distributed among several media, such as the data storage 1606.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

An aspect of the subject technology is directed to a method including receiving, by a search frontend, a query from a knowledge consumer, and processing the query via a processor. The processing includes generating embedding for the query, retrieving a plurality of learning objectives (LOs) relevant to the query based on the generated embeddings, and retrieving content relevant to the plurality of LOs for displaying to the knowledge consumer.

In some implementations, the query comprises a search query or a question asked in a natural language. The knowledge consumer can be a human user, a program, a model, or a machine.

In one or more implementations, the processor comprises an API.

In some implementations, retrieving the plurality of LOs comprises retrieving from an LOs vector database configured to store the plurality of LOs in vector forms.

In one or more implementations, retrieving content relevant to the plurality of LOs comprises retrieving content from an LO-to-content inverted index database.

In some implementations, the processing further comprises mapping an LO of the plurality of LOs to multimodal content by determining a first plurality of LOs that are prerequisites for that LO.

In one or more implementations, the processing further comprises retrieving, from an LO graph database, content of the first plurality of LOs in addition to content relevant to the LO of the plurality of LOs for display to the knowledge consumer.

In some implementations, the processing further comprises retrieving, from an LO graph database, content of prerequisites of the first plurality of LOs in addition to content relevant to the LO of the plurality of LOs and the content of the first plurality of LOs for display to the knowledge consumer.

In one or more implementations, the processing further comprises retrieving, from an LO graph database, content of prerequisites of the first plurality of LOs in addition to content relevant to the LO of the plurality of LOs and the content of the first plurality of LOs for display to the knowledge consumer.

In some implementations, an edge weight, retrieved from the per-consumer edge weights database, comprises a personalized edge weight for an individual knowledge consumer.

In one or more implementations, the personalized edge weight between an LO and a prerequisite LO is assigned a float value between zero and infinity (or normalized between zero and one) based on whether there was an individual prior knowledge consumption of the individual knowledge consumer or other factors affecting it, such as time since knowledge consumption, or clusters.

Another aspect of the subject technology is directed to a system including a processor and memory coupled to the processor, the memory storing instructions that, when executed by the processor, cause the processor to perform a method. The method includes receiving a query from a knowledge consumer, processing the query. The processing includes generating embedding for the query, retrieving a plurality of LOs relevant to the query based on the generated embeddings, and retrieving content relevant to the plurality of LOs for displaying to the knowledge consumer.

In some implementations, the memory is configured to store an LOs vector database configured to store the plurality of LOs in vector forms, and wherein retrieving the plurality of LOs comprises retrieving from the LOs vector database.

In one or more implementations, the memory is configured to store an LO-to-content inverted index database, and retrieving content relevant to the plurality of LOs comprises retrieving content from the LO-to-content inverted index database.

In some implementations, the processing further comprises mapping an LO of the plurality of LOs to multimodal content by determining a first plurality of LOs that are prerequisites for that LO.

In one or more implementations, the memory is configured to store a per-consumer edge weights database, and the processing further comprises retrieving, from the per-consumer edge weights database, edge weight information related to the first plurality of LOs that are prerequisites for that LO for a knowledge consumer.

In some implementations, an edge weight, retrieved from the per-consumer edge weights database, comprises a personalized edge weight for an individual knowledge consumer, and the personalized edge weight between an LO and a prerequisite LO is assigned a float value between zero and infinity (or normalized between zero and one) based on whether there was an individual prior knowledge consumption of the individual knowledge consumer.

In one or more implementations, the method further comprises causing the selected edge server to perform uplink and downlink tests to assess a network quality, and determining, based on test results, whether the network conditions meet criterion for a desired user experience.

In some implementations, retrieving the plurality of LOs comprises retrieving from an LOs vector database configured to store the plurality of LOs in vector forms, and the processing further comprises:
mapping an LO of the plurality of LOs to multimodal content by determining a first plurality of LOs that are prerequisites for that LO;
retrieving, from an LO graph database, content of the first plurality of LOs in addition to content relevant to LO of the LO of the plurality of LOs for display to the knowledge consumer;
retrieving, from the LO graph database, content of prerequisites of the first plurality of LOs in addition to content relevant to the LO of the LO of the plurality of LOs and the content of the first plurality of LOs for display to the knowledge consumer; and
retrieving, from a per-consumer edge weights database, edge weight information related to the first plurality of LOs that are prerequisites for that LO for a knowledge consumer.

In one or more implementations, an edge weight, retrieved from the per-consumer edge weights database, comprises a personalized edge weight for an individual knowledge consumer, and the personalized edge weight between an LO and a prerequisite LO is assigned a float value between zero and infinity (or normalized between zero and one) based on whether there was an individual prior knowledge consumption of the individual knowledge consumer.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method, comprising:
receiving, by a search frontend, a query from a knowledge consumer;
processing the query via a processor, the processing including:
generating embedding for the query;
retrieving a plurality of learning objectives (LOs) relevant to the query based on the generated embeddings;
retrieving content relevant to the plurality of LOs; and
providing the content relevant to the plurality of LOs for display to the knowledge consumer.

2. The method of claim 1, wherein the query comprises a search query or a question asked in a natural language, and the knowledge consumer comprises a human user, a machine or a computer program.

3. The method of claim 1, wherein the processor comprises an application programming interface (API).

4. The method of claim 1, wherein retrieving the plurality of LOs comprises retrieving from an LOs vector database configured to store the plurality of LOs in vector forms.

5. The method of claim 1, wherein retrieving content relevant to the plurality of LOs comprises retrieving content from an LO-to-content inverted index database.

6. The method of claim 1, wherein the processing further comprises mapping an LO of the plurality of LOs to multimodal content by determining a first plurality of LOs that are prerequisites for that LO.

7. The method of claim 6, wherein the processing further comprises retrieving, from an LO graph database, content of the first plurality of LOs in addition to content relevant to LO of the LO of the plurality of LOs for display to the knowledge consumer.

8. The method of claim 6, wherein the processing further comprises retrieving, from an LO graph database, content of prerequisites of the first plurality of LOs in addition to content relevant to the LO of the LO of the plurality of LOs and the content of the first plurality of LOs for display to the knowledge consumer.

9. The method of claim 6, wherein the processing further comprises retrieving, from a per-consumer edge weights database, edge weight information related to the first plurality of LOs that are prerequisites for that LO for a knowledge consumer.

10. The method of claim 9, wherein an edge weight, retrieved from the per-consumer edge weights database, comprises a personalized edge weight for an individual knowledge consumer.

11. The method of claim 10, wherein the personalized edge weight between an LO and a prerequisite LO is assigned a float value between zero and infinity based on whether there was an individual prior knowledge consumption of the individual knowledge consumer.

12. A system, comprising:
a processor; and
memory coupled to the processor, the memory storing instructions that, when executed by the processor, cause the processor to perform a method comprising:
receiving a query from a knowledge consumer;
processing the query, the processing including:
generating embedding for the query;
retrieving a plurality of LOs relevant to the query based on the generated embeddings;
retrieving content relevant to the plurality of LOs; and
providing the content relevant to the plurality of LOs for display to the knowledge consumer.

13. The system of claim 12, wherein the knowledge consumer comprises a human user, a machine or a computer program, and wherein the memory is configured to store an LOs vector database configured to store the plurality of LOs in vector forms, and wherein retrieving the plurality of LOs comprises retrieving from the LOs vector database.

14. The system of claim 12, wherein:
the memory is configured to store an LO-to-content inverted index database; and
retrieving content relevant to the plurality of LOs comprises retrieving content from the LO-to-content inverted index database.

15. The system of claim 12, wherein the processing further comprises mapping an LO of the plurality of LOs to multimodal content by determining a first plurality of LOs that are prerequisites for that LO.

16. The system of claim 15, wherein:
the memory is configured to store a per-consumer edge weights database; and
the processing further comprises retrieving, from the per-consumer edge weights database, edge weight information related to the first plurality of LOs that are prerequisites for that LO for a knowledge consumer.

17. The system of claim 16, wherein:
an edge weight, retrieved from the per-consumer edge weights database, comprises a personalized edge weight for an individual knowledge consumer; and
the personalized edge weight between an LO and a prerequisite LO is assigned a float value between zero and infinity based on whether there was an individual prior knowledge consumption of the individual knowledge consumer.

18. A method, comprising:
receiving, by a search frontend, a search query or a question asked in a natural language from a knowledge consumer; and
processing the query via a processor, the processing including:
retrieving a plurality of LOs relevant to the query based on an embedding generated for the query;
retrieving content relevant to the plurality of LOs from an LO-to-content inverted index database; and
providing the content relevant to the plurality of LOs for display to the knowledge consumer.

19. The method of claim 18, wherein:
the knowledge consumer comprises a human user, a machine or a computer program;
retrieving the plurality of LOs comprises retrieving from an LOs vector database configured to store the plurality of LOs in vector form; and
the processing further comprises:
mapping an LO of the plurality of LOs to multimodal content by determining a first plurality of LOs that are prerequisites for that LO;
retrieving, from an LO graph database, content of the first plurality of LOs in addition to content relevant to the LO of the plurality of LOs for display to the knowledge consumer;
retrieving, from the LO graph database, content of prerequisites of the first plurality of LOs in addition to content relevant to the LO of the plurality of LOs and the content of the first plurality of LOs for display to the knowledge consumer; and
retrieving, from a per-consumer edge weights database, edge weight information related to the first plurality of LOs that are prerequisites for that LO for a knowledge consumer.

20. The method of claim 19, wherein, an edge weight, retrieved from the per-consumer edge weights database, comprises a personalized edge weight for an individual knowledge consumer, and the personalized edge weight between an LO and a prerequisite LO is assigned a float value between zero and infinity based on whether there was an individual prior knowledge consumption of the individual knowledge consumer.
